(19) United States
(12) Patent Application Publication
(10) Pub. No.: US 2004/0086682 A1
(43) Pub. Date: May 6, 2004

(54) Recyclable, rubber-like thermoplastic backing material used in a throw-in mat for a vehicle floor

(76) Inventors: Jeffrey L. Rice, Chambersburg, PA (US); Steve P. Hammond, Shippensburg, PA (US); Randy Heckendorn, Carlisle, PA (US); Randy Boyd, Newburg, PA (US); Dennis Young, Mechanicsburg, PA (US)

Correspondence Address: ARTZ & ARTZ, P.C., 28333 TELEGRAPH RD., SUITE 250, SOUTHFIELD, MI, 48034, US

(21) Appl. No.: 10/065,639

(22) Filed: Nov. 5, 2002

(51) Int. Cl. B32B 33/00; D05C 17/02; B29C 31/08

(52) U.S. Cl. 428/95; 428/97; 264/257

(57) ABSTRACT

A recyclable, thermoplastic backing material having the feel and weight of a rubber backing for use on a throw in mat. As compared with conventional rubber backed throw-in mats, the new thermoplastic material does not require a latex backing to adhere the rubber backing material to the primary backing layer. This may lead to decreased manufacturing costs associated with purchasing and applying the latex backing material. Further, because the material is recyclable, decreased costs associated with waste may be achieved.

### BACKGROUND OF INVENTION

### TECHNICAL FIELD

The present invention relates generally to floor mats for vehicles and the like, and more particularly to a recyclable, rubber-like thermoplastic backing material used in a throw-in mat for a vehicle floor.

### BACKGROUND

Throw-in mats are often provided in vehicles for protecting carpeted vehicle floors. These mats typically include nibs formed on the back of the mat to grip the carpeted floor. The nibs extend from a backing layer that is secured to a primary backing layer and the carpet pile, and a carpet pile is tufted (sewn) into the primary backing layer.

As shown in FIG. 1, a typical throw in mat 10 according to the prior art 10 includes a primary backing layer 12 having first and second sides 14,16 thereof. A carpet pile 18 is tufted, or sewn, into the first side 14 of the primary backing layer 12. The primary backing layer 12 is preferably a woven polypropylene or non-woven polyester material.

Coupled to the back side of the primary backing layer 12 is a latex backing layer 13 and a rubber backing material 15. The latex backing layer 13 is necessary to adhere the tufted carpet pile 18 to the primary backing layer 12.

Alternatively, the primary backing layer 12 and the rubber backing material 15 (without the latex backing layer 13) could also be made of a thermoplastic material, which has a cost savings over rubber materials. However, typical thermoplastic backing materials that are used in throw-in mats lack the feel of rubber mats that is highly desirable among consumers. This is due primarily to the desire to produce throw-in mats that are light and inexpensive.

Another problem with currently available throw-in mats is that the thermoplastic backing material is not recyclable. This leads to increase cost in manufacturing the throw-in mats associated with waste removal.

It is therefore an object of the present invention to provide a thermoplastic backing material for use in throw-in mats that has the feel of rubber. Further, it is highly desirable if this thermoplastic material is also recyclable.

### SUMMARY OF INVENTION

In accordance with the above objects, a new thermoplastic backing for a throw in mat is proposed. The thermoplastic backing has the feel and weight of a rubber backing. Further, the backing is recyclable, thereby reducing costs associated with waste disposal.

In addition, as compared with rubber backed throw-in mats, the new thermoplastic material does not require a latex backing to adhere the rubber-like backing material to the tufted carpet pile and primary backing layer. This may lead to decreased manufacturing costs associated with purchasing and applying the latex backing material.

Other objects and advantages of the present invention will become apparent upon considering the following detailed description and appended claims, and upon reference to the accompanying drawings.

### BRIEF DESCRIPTION OF DRAWINGS

FIG. 1 illustrates a section view of a throw-in mat according to the prior art;

FIG. 2 illustrates a section view of a throw-in mat according to a preferred embodiment of the present invention;

FIG. 3 illustrates a process for making the thermoplastic backing material used in FIG. 2; and

FIGS. 4 and 5 illustrates the process for adding the thermoplastic material made in FIG. 2 to the primary backing material and carpet pile to form the throw-in mat of FIG. 2.

### DETAILED DESCRIPTION

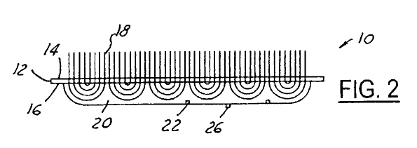

Referring now to FIG. 2, a throw-in mat 10 is shown in accordance with the present invention. As shown, the throw-in mat 10 includes a primary backing layer 12 having first and second sides 14,16 thereof. A carpet pile 18 is tufted, or sewn, into the first side 14 of the primary hacking layer 12. The primary backing layer 12 is preferably a woven polypropylene or non-woven polyester material.

The carpet pile 18 may be of many constructions well known to those of skill in the art. Two carpet constructions commonly used include Shiva and Paramount.

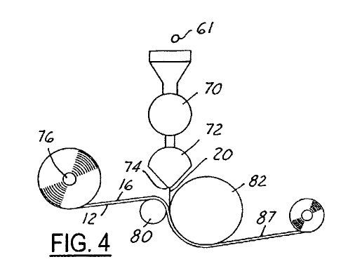

A recyclable thermoplastic backing material 20 is secured to the second side 16 of the primary backing layer 12. The recyclable thermoplastic backing material 20 is preferably a recyclable thermoplastic material having the look and feel of a rubber backing. One preferred composition of the recyclable thermoplastic backing material 20 is shown below in Table 1. The recyclable thermoplastic backing material 20 is preferably extruded onto the primary backing layer 12. This is shown below in FIG. 4. The recyclable thermoplastic backing material 20 is then heated under pressure to form a desired pattern on the bottom of the recyclable thermoplastic backing material 20. This pattern can include a number of nibs 26 and grooves 22 to help secure the mat 10 to a carpeted vehicle floor.

The composition of the backing material 20 is preferably based on an ethylene-octene copolymer formed using a metallocene catalyst and other processing aids. The ethylene-octene copolymer is then further processed to form the backing material 20 that is thermoplastic and recyclable. The backing material 20 provides a rubber feeling and weighted material without the additional costs associated with a rubber backing material, costs that include manufacturing costs and recycling costs.

Metallocene is the general name for a family of catalysts that have been used in forming ultra low-density polyethylene (ULDPE) polymers. Two preferred metallocene catalyst materials are Exact, manufactured by Exxon, and Engage, manufactured by Pont Dow Elastomers.

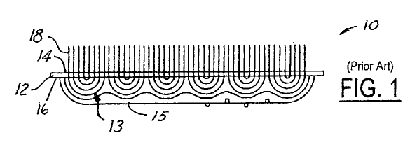

Table 1 below shows one preferred composition for the recyclable thermoplastic backing material 20 of FIG. 1.

TABLE 1

| INGREDIENT | DESCRIPTION | WEIGHT |
|---|---|---|
| Ethylene-octene | Thermoplastic | 25 |
| copolymer formed using | copolymer (.885 density | |
| metallocene catalyst | and 30 melt index) | |
| Ethylene-octene | Thermoplastic | 13.335 |
| copolymer formed using | copolymer (.885 density | |
| metallocene catalyst | and 3 melt index) | |
| Paraffinic Oil | Plasticizer | 3.75 |
| Zinc Oxide | Additive | .4275 |
| Heat Stabilizer | Additive | .30 |
| Processing Aid | Additive | .15 |
| Low Density | Thermoplastic Additive | 1.5375 |
| Polyethylene | | |
| Calcium Carbonate | Filler | 55.5 |
| (CaCO₃) | | |

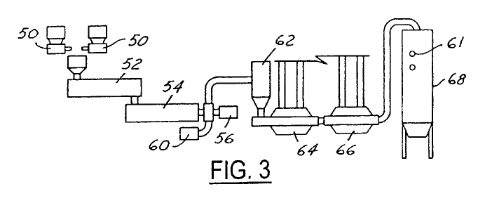

While the ingredients as listed in Table 1 are shown in a particular order from top to bottom, it is likely that the order of addition of ingredients will not materially affect the composition of the backing material 20 to be formed as described below in FIG. 3.

Of course, one of ordinary skill in the art appreciates that the composition of the backing material 20 is merely representative of a potentially limitless variations in the material compositions based on ethylene-octene copolymers formed using metallocene catalyst and is not intended to be limiting. Further, other thermoplastic copolymers other than ethylene-octene, or other thermoplastic polymer or copolymer materials blended with the ethylene-octene copolymer, are specifically contemplated by the present invention as long as they meet the requirements of being recyclable and providing a rubber feeling and weighted backing material.

FIG. 3 shows the process for forming the recyclable thermoplastic backing material 20. The major ingredients for forming the recyclable thermoplastic backing material 20 as described in Table 1 above are first loaded into one or more loss in weight feeders 50. Again, as described above, it is preferable that the ethylene-octene copolymer having the 30-melt index is added to the feeder 50 prior to introduction of the other major ingredients. The feeders 50 feed the raw materials into a continuous mixer 52, which mixes the raw materials. The mixer 52 is coupled to an extruder 54, which mixes, melts, and extrudes the raw materials in a method well known in the art. The extruded raw materials are then pelletized using an underwater pelletizer 56, which is fed water from a tank (not shown) through a water pump 60, therein forming pellets 61. The pellets 61 are then introduced to a spin dryer 62. The spun dry pellets 61 fall into a fluidized bed/dryer 64 to further dry the pellets. The pellets 61 then enter a cooler/classifier 66 that cools the pellets 61 and separates the pellets 61 by size. The sized pellets 61 are then sent to a silo 68 for storage. The silo is maintained below about 25 degrees Celsius (about 80 degrees Fahrenheit) to prevent the pellets 61 from sticking together. The sized pellets 61 are then available to form the throw-in mat as described below in FIG. 3.

Referring now to FIG. 4, the sized pellets 61 are introduced, or fed, to an extruder 70 for melting. The melted pellets 61 then enter a die 72, which forces the material out at the bottom 74 at a desired thickness. Preferably, the temperature of the melted pellets 61 is approximately 165 to 185 degrees Celsius, and more preferably about 175 degrees Celsius (350 degrees Fahrenheit), as it exits the bottom 74 of the die 72. A feed roll 76 containing the primary backing layer 12 coupled to the carpet pile 18 is unrolled and closely coupled to the die 72. The melted pellet 61 material is pressed to the second side 16 of the primary backing layer 12 between a pressure roll 80 and a chill roll 82 and rolled onto a roller 84. The rolls 80, 82 apply sufficient pressure to adhere the recyclable thermoplastic backing material 20 to the primary backing layer 12.

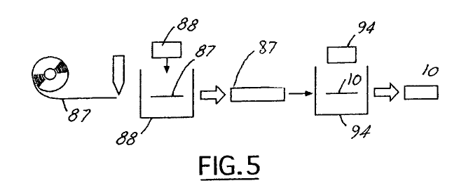

As shown in FIG. 5, the rolled material 87 is then cut to an appropriate size and placed in a mat press 88. The rolled material 87 then molded under heat and pressure for a sufficient period of time to allow the thermoplastic backing material 20 to flow to form the desired shape. As one of ordinary skill in the art recognizes, the amount of heat, pressure and time may be varied depending upon the composition of the thermoplastic backing material and the desired surface quality. Normal pressings of 20-25 tons at approximately 155 and 175 degrees Celsius, and more preferably at about 165 degrees Celsius (approximately 330 degrees Fahrenheit), for about 20 seconds are used to flow the thermoplastic backing material having a composition as shown in Table 1.

By modifying the mold itself, the pressing process can also form the nibs 26 and grooves 22 on the bottom surface of the recyclable thermoplastic backing material 20.

When the cycle is complete, the rolled material 87 is removed and placed into a cold press 94, where pressure is applied to cool the material, therein forming the throw in mat 10. The mat 10 is removed from the cold press 94 and may be subsequently trimmed to a desired shape.

Table 2 below illustrates the various performance characteristics of throw in mats 10 made with made with Shiva and Paramount carpet pile 18 material in accordance with the present invention.

TABLE 2

| | | | PARAMOUNT | SHIVA WITH 52 |
|---|---|---|---|---|
| | | | WITH 52 OZ. | OZ. |
| | | | THERMOPLASTIC | THERMOPLASTIC |
| | CLASSIFICATION | SPECIFICATION | BACKING | BACKING |
| TEST | CRITERIA | LIMITS | MATERIAL | MATERIAL |
| Shrink | % | +/−2 | 0.00 | 0.00 |
| Water MD | | | | |
| Shrink | % | +/−2 | 0.00 | 0.00 |
| Water AMD | | | | |
| Shrink | % | +/−2 | 0.40 | 0.75 |
| Heat MD | | | | |
| Shrink | % | +/−2 | 0.00 | 0.00 |
| Heat AMD | | | | |
| Dim Stab | % | +/−2 | 0.40 | 0.40 |
| Exp/Cont | | | | |
| MD | | | | |
| Dim Stab | % | +/−2 | 0.20 | 0.25 |
| Exp/Cont | | | | |
| AMD | | | | |
| Tensile Str | Newtons | 400 MIN | 869.40 | 888.60 |
| MD | | | | |
| Tensile Str | Newtons | 400 MIN | 766.38 | 792.88 |
| AMD | | | | |
| Tensile Str | Newtons | 400 MIN | 926.80 | 913.80 |
| Imrsd MD | | | | |
| Tensile Str | Newtons | 400 MIN | 769.38 | 736.88 |
| Imrsd AMD | | | | |
| Tensile aft | % Change | 80% | 100.64 | 93.18 |
| 112.8 kJ % | | | | |
| Of Orig MD | | | | |
| Tensile aft | % Change | 80% | 92.02 | 89.91 |
| 112.8 kJ % | | | | |
| Of Orig | | | | |
| AMD | | | | |
| Tensile aft | Newtons | RESULTS | 857.00 | 828.00 |
| 112.8 kJ MD | | | | |
| Tensile aft | Newtons | RESULTS | 705.25 | 712.88 |
| 112.8 kJ | | | | |
| AMD | | | | |
| Trap Tear | Newtons | 90 | 255.80 | 270.40 |
| MD | | | | |
| Trap Tear | Newtons | 50 | 201.00 | 197.60 |
| AMD | | | | |
| Trap Tear | Newtons | 90 | 272.80 | 282.20 |
| Imrsd MD | | | | |
| Trap Tear | Newtons | 50 | 215.60 | 203.00 |
| Imrsd | | | | |
| AMD | | | | |
| Tuft Bind | Newton | 16 | 20.79 | 20.31 |
| Orig | | | | |
| Tuft Bind | Newton | 10 | 21.80 | 15.49 |
| H/A | | | | |
| Adh | N/mm | +/−0.96 | Can't Separate | Can't Separate |
| Cpt/Mat | | | | |
| Orig MD | | | | |
| Adh | N/mm | +/−0.96 | Can't Separate | Can't Separate |
| Cpt/Mat | | | | |
| Orig AMD | | | | |
| Adh | N/mm | +/−0.96 | Can't Separate | Can't Separate |
| Cpt/Mat | | | | |
| Imrsd MD | | | | |
| Adh | N/mm | +/−0.96 | Can't Separate | Can't Separate |
| Cpt/Mat | | | | |
| Imrsd AMD | | | | |
| Adh | N/mm | +/−0.96 | Can't Separate | Can't Separate |
| Cpt/Mat | | | | |
| Cyc MD | | | | |
| Adh | N/mm | +/−0.96 | Can't Separate | Can't Separate |
| Cpt/Mat | | | | |
| Cyc AMD | | | | |
| Cld Resist | Rate | Satisfactory? | Satisfactory | Satisfactory |
| H/A FF MD | | | | |
| Cld Resist | Rate | Satisfactory? | Satisfactory | Satisfactory |
| H/A FF | | | | |
| AMD | | | | |
| Cld Resist | Rate | Satisfactory? | Satisfactory | Satisfactory |
| Orig FF MD | | | | |
| Cld Resist | Rate | Satisfactory? | Satisfactory | Satisfactory |
| Orig FF | | | | |
| AMD | | | | |
| Abr H18 | Cycles | 2000 | 2000.00 | 2000.00 |
| 1000 g | | | | |
| 2000 c | | | | |
| Fiber Loss | Grams | 0.2 | 0.07 | 0.18 |
| H18 1000 g | | | | |
| 300 c | | | | |
| Heat Aging @ | Rate | 4 MIN | 5.00 | 5.00 |
| 90° C. | | | | |
| Flam MD | mm/min | 100 MAX | 47.80 | 41.70 |
| Flam AMD | mm/min | 100 MAX | 36.60 | 25.40 |
| Breaking | Newton | 330 | 904.20 | 895.40 |
| Strength | | | | |
| MD | | | | |
| Breaking | Newton | 330 | 741.88 | 765.00 |
| Strength | | | | |
| AMD | | | | |
| Tongue | Newton | 53.4 | 72.32 | 71.98 |
| Tear MD | | | | |
| Tongue | Newton | 53.4 | 89.88 | 96.32 |
| Tear AMD | | | | |
| Resist | gm | 0.2 | 0.02 | 0.03 |
| Beard/Fuzz | | | | |
| H18 | | | | |
| Abr H18 | Cycles | RESULTS | 3900.00 | 9525.00 |
| 1000 g | | | | |
| Failure | | | | |
| Nib Wear | Rate | Satisfactory? | Satisfactory | Satisfactory |
| MD | | | | |
| Nib Wear | Rate | Satisfactory? | Satisfactory | Satisfactory |
| AMD | | | | |

The throw-in mats of the present invention offer many advantages over throw in mats 10 of the prior art. For example, the thermoplastic backing material 20 of the throw-in mats 10 is recyclable. This limits manufacturing costs in terms of waste removal and can help to minimize raw material costs. Second, the throw-in mats 10 have the look and feel of rubber at a cost savings in terms of manufacture and raw material costs over rubber. Third, the thermoplastic backing material does not require a latex backing layer in order to adhere the backing material to the primary backing layer. Fourth, the throw-in mats 10 are relatively easy and cost-effective to manufacture.

While the invention has been described in terms of preferred embodiments, it will be understood, of course, that the invention is not limited thereto since modifications may be made by those skilled in the art, particularly in light of the foregoing teachings.

1. A throw-in mat for use in a vehicle having a rubber-like fee comprising:
a primary backing layer having a first side and a second side;
a carpet pile sewn to said first side; and
a recyclable, thermoplastic backing material coupled to said second side.

2. The throw-in mat of claim 1, wherein the composition of said recyclable, thermoplastic backing material comprises an ethylene-octene copolymer.

3. The throw-in mat of claim 2, wherein said ethylene-octene copolymer is formed using a metallocene catalyst.

4. The throw-in mat of claim 2, wherein a portion of said ethylene-octene copolymer has a melt index of approximately 30.

5. The throw-in mat of claim 4, wherein a second portion of said ethylene-octene copolymer has a melt index of approximately 3.

6. The throw-in mat of claim 3, wherein said metallocene catalyst is selected from the group consisting of Exact, manufactured by Exxon, and Engage, manufactured by Du Pont Dow Elastomers.

7. A recyclable, thermoplastic backing material for use a throw-in mat comprising:
a first recyclable thermoplastic material having a melt index of approximately 25-35 and a density of approximately 0.7 to 1.0; and
a second recyclable thermoplastic material having a melt index of approximately 1-5 and a density of approximately 0.7 to 1.0.

8. The backing material of claim 7, wherein said first recyclable thermoplastic material comprises an ethylene-octene copolymer formed using a metallocene catalyst.

9. The backing material of claim 8, wherein said second recyclable thermoplastic material comprises an second ethylene-octene copolymer formed using said metallocene catalyst.

10. The backing material of claim 7, wherein said first recyclable thermoplastic material comprises a first ethylene-octene copolymer and wherein said second recyclable thermoplastic material comprises an second ethylene-octene copolymer, each of said first ethylene-octene copolymer and said second ethylene-octene copolymer formed using a metallocene catalyst.

11. The backing material of claim 7, wherein said metallocene catalyst is selected from the group consisting of Exact, manufactured by Exxon, and Engage, manufactured by Du Pont Dow Elastomers.

12. A method for forming a throw-in mat having a rubber-like feel and weight, the method comprising:
providing a carpet pile sewn through a first side of a primary backing layer;
forming a recyclable, thermoplastic backing material;
coupling said recyclable, thermoplastic backing material to a second side of said primary backing layer to form the throw in mat, said second side being opposite of said first side;
introducing the thrown-in mat to a mat press;
pressing the throw-in mat at a desired temperature and a desired pressure for a predetermined period of time within said mat press to form said recyclable, thermoplastic backing material to a desired shape;
removing said throw-in mat from said mat press; and
cooling said throw-in mat in a cold press.

13. The method of claim 12, wherein forming a thermoplastic backing material comprises:
introducing a plurality of raw materials to a mixing device, said plurality of raw materials including a recyclable, thermoplastic polymer; and
mixing said plurality of raw materials within said mixing device to form a recyclable, thermoplastic backing material.

14. The method of claim 12, wherein said recyclable, thermoplastic polymer comprises a first ethylene-octene copolymer formed using a metallocene catalyst and having a melt index of approximately 25-35 and a density of approximately 0.7 to 1.0.

15. The method of claim 14, wherein said recyclable, thermoplastic polymer further comprises a second ethylene-octene copolymer formed using said metallocene catalyst and having a melt index of approximately 2-4 and a density of approximately 0.7 to 1.0.

16. The method of claim 12, introducing a plurality of raw materials to a mixing device and mixing said plurality of raw materials comprises:
introducing a plurality of raw materials to a loss in weight feeder, said plurality of raw materials including a recyclable, thermoplastic polymer;
feeding said plurality of raw materials from said loss in weight feeder to a continuous mixer;
mixing said plurality of raw materials within said mixer to form a mixture;
introducing said mixture to an extruder;
extruding said mixture in said extruder to form an extruded material;
pelletizing said extruded material with an underwater pelletizer to form a plurality of pellets;
introducing at least one of said plurality of pellets to an extruder;
melting said at least one of said plurality of pellets to form a recyclable, thermoplastic backing material; and
forcing said recyclable, thermoplastic backing material out of a bottom of said extruder at a desired temperature.

17. The method of claim 16, wherein said desired temperature is between approximately 165 and 185 degrees Celsius.

18. The method of claim 12, wherein pressing the throw in mat comprises pressing the throw-in mat at a desired temperature and a desired pressure for a predetermined period of time within said mat press to form said recyclable, thermoplastic backing material to a desired shape;
wherein said desired temperature, said desired pressure, and said predetermined period of time are sufficient for said recyclable, thermoplastic backing material to flow within said extruder to form a desired shape.

19. The method of claim 12, wherein said desired temperature is between approximately 165 and 185 degrees Celsius and said predetermined period of time is approximately 20 seconds.

20. The method of claim 12, wherein said desired pressure is between 20 and 25 tons and said predetermined period of time is approximately 20 seconds.
